(19) United States
(12) Patent Application Publication
(10) Pub. No.: US 2014/0274105 A1
(43) Pub. Date: Sep. 18, 2014

(54) SYSTEMS AND METHODS FOR COEXISTENCE IN WLAN AND LTE COMMUNICATIONS

(71) Applicant: QUALCOMM Incorporated, San Diego, CA (US)

(72) Inventor: Jibing WANG, San Diego, CA (US)

(73) Assignee: QUALCOMM Incorporated, San Diego, CA (US)

(21) Appl. No.: 13/947,935

(22) Filed: Jul. 22, 2013

Related U.S. Application Data
(60) Provisional application No. 61/785,671, filed on Mar. 14, 2013.

(51) Int. Cl. H04W 52/24; H04W 72/04

(52) U.S. Cl. CPC H04W 52/244; H04W 72/044
USPC 455/454

(57) ABSTRACT

This disclosure provides coexistence strategies for a combined wireless communications device using multiple wireless protocols, such as WLAN and LTE. Transmission power of a system using one wireless protocol is dynamically adjusted based on a determination of operating characteristics of a system using another wireless protocol. At least one of the operating characteristics may be determined from an allocation of network resources, examples of which include the transmission frequency for an upcoming transmission and the transmission power for an upcoming transmission. Further, the transmission power may be adjusted when the reception quality of the system using the other wireless protocol is below a desired threshold.

### RELATED APPLICATIONS

This application claims priority to U.S. Provisional Patent Application Ser. No. 61/785,671, filed Mar. 14, 2013.

### FIELD OF THE PRESENT DISCLOSURE

The present disclosure generally relates to wireless communications and more particularly relates to systems and methods for enhancing the coexistence of wireless local area network (WLAN) and long term evolution (LTE) networks.

### BACKGROUND

Wireless communications devices may have multiple wireless communication systems configured to support multiple wireless protocols to gain flexibility, to provide enhanced capabilities and to exploit different advantages that may be presented by the respective protocols. Despite these advantages, the presence of multiple wireless communications systems in a single device may pose coexistence issues. For example, the use of multiple radio frequency (RF) transceivers raises the potential for one system to interfere with the transmission or reception of another system. In one aspect, a device may employ one wireless protocol to provide wireless wide area network (WWAN) capabilities using cellular-based communications, such as Long Term Evolution (LTE) and may employ another wireless protocol to provide wireless local area network (WLAN) capabilities. Due to nonlinear aspects of the respective radios, the WLAN and LTE transmission frequencies may combine and create interference known as intermodulation distortion (IMD) in the LTE reception band. As a result, performance of the LTE system may be degraded.

Accordingly, it would be desirable to provide coexistence strategies for a wireless communications device operating using multiple wireless protocols, such as WLAN and LTE systems. It would also be desirable to dynamically control operation of one wireless protocol based on operational characteristics of another wireless protocol to reduce IMD. As described below, this disclosure achieves these and other goals.

### SUMMARY

This disclosure is directed to systems and methods for dynamically adjusting transmission power for one wireless transceiver based upon operating characteristics of another wireless transceiver. As such, systems of this disclosure may include a wireless communications device having a first transceiver that may operate using a first wireless protocol, a second transceiver that may operate using a second wireless protocol, and a coexistence manager that may be configured to receive an allocation of network resources using the first transceiver, predict intermodulation distortion (IMD) regarding an upcoming transmission using the first transceiver based, at least in part, on at least one characteristic determined from the allocation of network resources, and selectively reduce transmit power at the second transceiver based, at least in part, on the predicted IMD when reception quality at the first receiver is below a desired threshold. The characteristic may be a transmission frequency for the upcoming transmission. For example, the coexistence manager may determine a current channel on which the second transceiver is operating and predict IMD based, at least in part, on the transmission frequency of the upcoming transmission and the current channel. The characteristic may also be a transmission power for the upcoming transmission. As desired, the coexistence manager may use both characteristics to predict IMD.

In one aspect, the allocation of network resources is a resource block (RB) assignment. In another aspect, the coexistence manager may determine reception quality at the first receiver based, at least in part, on a performance metric reported by the second transceiver. Further, the coexistence manager may also determine an amount by which to reduce transmission power for the second transceiver based, at least in part, on at least one of the reception quality at the first transceiver and the at least one characteristic determined from the allocation of network resources.

In one embodiment, the first wireless protocol is a long term evolution (LTE) protocol and wherein the second wireless protocol is a wireless local area network (WLAN) protocol.

This disclosure also includes methods for providing coexistence between a first wireless protocol and a second wireless protocol. In one aspect, the method may include receiving an allocation of network resources using the a first transceiver configured to operate using the first wireless protocol, predicting IMD regarding an upcoming transmission at the first transceiver based, at least in part, on at least one characteristic determined from the allocation of network resources, and selectively reducing transmit power at a second transceiver configured to operate using the second wireless protocol based, at least in part, on the predicted IMD when reception quality at the first receiver is below a desired threshold. The characteristic may be a transmission frequency for the upcoming transmission. For example, the method may include determining a current channel on which the second transceiver is operating, such that predicting IMD is based, at least in part, on the transmission frequency of the upcoming transmission and the current channel. The characteristic may also be a transmission power for the upcoming transmission. As desired, predicting IMD may be based, at least in part, on both characteristics.

In one aspect, the allocation of network resources is a RB assignment. In another aspect, the method may include determining reception quality at the first receiver based, at least in part, on a performance metric reported by the second transceiver. The method may also include determining an amount by which to reduce transmission power for the second transceiver based, at least in part, on at least one of the reception quality at the first transceiver and the at least one characteristic determined from the allocation of network resources.

As desired, the method may also include determining an amount by which to reduce transmission power for the second transceiver based, at least in part, on at least one of the reception quality at the first transceiver and the at least one characteristic determined from the allocation of network resources.

In one embodiment, the first wireless protocol is an LTE protocol and wherein the second wireless protocol is a WLAN protocol.

The systems of this disclosure may also include a non-transitory processor-readable storage medium for providing coexistence between a first wireless protocol and a second wireless protocol in a wireless communications device, the processor-readable storage medium having instructions thereon, when executed by a processor, to cause the wireless communications device to receive an allocation of network resources using the a first transceiver configured to operate using the first wireless protocol, predict IMD regarding an upcoming transmission at the first transceiver based, at least in part, on at least one characteristic determined from the allocation of network resources, and selectively reduce transmit power at a second transceiver configured to operate using the second wireless protocol based, at least in part, on the predicted IMD when reception quality at the first receiver is below a desired threshold. The characteristic may be a transmission frequency for the upcoming transmission. For example, the storage medium may include instructions to cause the wireless communications device to determine a current channel on which the second transceiver is operating, such that predicting IMD is based, at least in part, on the transmission frequency of the upcoming transmission and the current channel. The characteristic may also be a transmission power for the upcoming transmission. As desired, predicting IMD may be based on both characteristics.

In one aspect, the allocation of network resources is a RB assignment. In another aspect, the storage medium may include instructions to cause the wireless communications device to determine reception quality at the first receiver based, at least in part, on a performance metric reported by the second transceiver. The storage medium may also include instructions to cause the wireless communications device to determine an amount by which to reduce transmission power for the second transceiver based, at least in part, on at least one of the reception quality at the first transceiver and the at least one characteristic determined from the allocation of network resources.

As desired, the storage medium may also include instructions to cause the wireless communications device to determine an amount by which to reduce transmission power for the second transceiver based, at least in part, on at least one of the reception quality at the first transceiver and the at least one characteristic determined from the allocation of network resources.

In one embodiment, the first wireless protocol is an LTE protocol and wherein the second wireless protocol is a WLAN protocol.

### BRIEF DESCRIPTION

Further features and advantages will become apparent from the following and more particular description of the preferred embodiments of the disclosure, as illustrated in the accompanying drawing, and in which like referenced characters generally refer to the same parts or elements throughout the views, and in which:

FIG. 1 schematically depicts a wireless environment including communication using multiple wireless protocols, according to one embodiment of the disclosure;

FIG. 2 schematically depicts functional blocks of a wireless communications device configured to provide coexistence between multiple wireless protocols, according to one embodiment of the disclosure;

FIG. 3 is a schematic representation of a format of an LTE radio frame; and

FIG. 4 is a flowchart showing an exemplary routine for predicting IMD and adjusting transmission power, according to one embodiment of the disclosure.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

The terms second level and first level, high and low and 1 and 0, as used in the following description may be used to describe various logic states as known in the art. Particular voltage values of the second and first levels are defined arbitrarily with regard to individual circuits. Furthermore, the voltage values of the second and first levels may be defined differently for individual signals such as a clock and a digital data signal. Although specific circuitry has been set forth, it will be appreciated by those skilled in the art that not all of the disclosed circuitry is required to practice the techniques of the disclosure. Moreover, certain well known circuits have not been described, to maintain focus on the disclosure. Similarly, although the description refers to logical “0” and logical “1” or low and high in certain locations, one skilled in the art appreciates that the logical values can be switched, with the remainder of the circuit adjusted accordingly, without affecting operation of the present disclosure.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the disclosure in any manner and may change depending upon context. Further, sequential terms such as first and second may be used to distinguish similar elements, but may be used in other orders or may change also depending upon context.

Embodiments are described herein with regard to a wireless communications device, which may include any suitable type of user equipment, such as a system, subscriber unit, subscriber station, mobile station, mobile wireless terminal, mobile device, node, device, remote station, remote terminal, terminal, wireless communication device, wireless communication apparatus or user agent. Further examples of a wireless communications device include mobile devices such as a cellular telephone, cordless telephone, Session Initiation Protocol (SIP) phone, smart phone, wireless local loop (WLL) station, personal digital assistant (PDA), laptop, handheld communication device, handheld computing device, satellite radio, wireless modem card and/or another processing device for communicating over a wireless system. Moreover, embodiments may also be described herein with regard to a base station. A base station may be utilized for communicating with one or more wireless nodes and may be termed also be called and exhibit functionality associated with an access point, node, Node B, evolved NodeB (eNB) or other suitable network entity. A base station communicates over the air-interface with wireless terminals. The communication may take place through one or more sectors. The base station may act as a router between the wireless terminal and the rest of the access network, which may include an Internet Protocol (IP) network, by converting received air-interface frames to IP packets. The base station may also coordinate management of attributes for the air interface, and may also be the gateway between a wired network and the wireless network.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

As noted above, aspects of this disclosure are related to the use of multiple wireless protocols in a wireless communications device. Although the increase in flexibility and capability associated with the use of multiple wireless protocols is desirable, various types of conflicts may exist depending upon the technologies being used. For example, intermodulation distortion (IMD) is a type of interference that may result from certain combinations of the frequencies at which the wireless protocols operate. Due to non-linearities present in the analog signal processing blocks of the wireless communications device, such as in the low noise amplifier (LNA) or in the switches, integer multiples of frequency components from each system may add or subtract to cause unwanted signals at different frequencies. Accordingly, IMD has the potential to disrupt or reduce performance in wireless communications systems. IMD may also affect performance in other systems relying on wireless communication, such as a global positioning system (GPS).

In one aspect, IMD resulting from transmission using a multiple wireless protocols may cause a performance degradation in reception of one of the wireless protocols. For example, in the context of a wireless communications device configured to operate using the Long Term Evolution (LTE) protocol and a wireless local area network (WLAN) protocol conforming to the Institute for Electrical and Electronic Engineers (IEEE) 802.11 family of standards, IMD resulting from LTE and WLAN transmissions may cause a loss of LTE reception sensitivity.

Since IMD results from known combinations of frequencies, the potential for performance degradation may be identified based on operating characteristics of the wireless communications device. Within the 5.4 GHz WLAN frequency band, specific instances include second order IMD at channel B7 resulting from the difference between the WLAN frequency and the LTE uplink frequency and third order IMD at channels B2, B3, B4 and B25 resulting from the difference between the WLAN frequency and two times the LTE uplink frequency. Further, within the 2.4 GHz WLAN frequency band, specific instances include third order IMD at channel B7 resulting from the difference between two times the LTE uplink frequency and the WLAN frequency and third order IMD at channels B18 and B20 resulting from the difference between the WLAN frequency and two times the LTE uplink frequency. At each combination, it may be determined that IMD is generated at the LTE downlink frequency. Other instances of problematic IMD may be identified depending upon the wireless protocols being employed and the relevant operating characteristics.

To help illustrate aspects of this disclosure related to reducing the effects of IMD, a representative example of a wireless environment 100 wireless communications device 100 is depicted in FIG. 1. In this simplified embodiment, a wireless communications device 102 having multiple radio access technologies (RATs) operates using multiple wireless protocols to communicate with base station 104, using a first wireless protocol, such as LTE, and with access point 106 using a second wireless protocol, such as WLAN. In other embodiments, suitable wireless protocols may include code division multiple access (CDMA) networks, high speed packet access (HSPA(+)), high-speed downlink packet access (HSDPA), global system for mobile communications (GSM), enhanced data GSM environment (EDGE), WiMax®, BLUETOOTH® (Bluetooth), ZigBee®, wireless universal serial bus (USB), and the like.

FIG. 2 depicts functional blocks of wireless communications device 102 associated with the reception and transmission of signals using the wireless protocols. Generally, wireless communications device 102 may employ an architecture in which the lower levels of the wireless protocol stack are implemented through firmware and/or hardware in respective RAT modules. As shown, LTE module 202 implements a data link layer and controls access to the wireless medium through radio link controller (RLC) 204 which may be configured to perform functions related to the handling and processing of frames of data including verification, acknowledgment, routing, formatting and the like. Incoming and outgoing frames are exchanged between RLC 204 and physical layer (PHY) 206. Together, RLC 204 and PHY 206 modulate frames of information according to the LTE protocol and provide the analog processing and RF conversion necessary to transmit and receive wireless signals through antenna 208. Analogously, WLAN module 210 implements a data link layer in the form of media access controller (MAC) 212 and exchanges incoming and outgoing frames with PHY 214, which may transmit and receive signals through antenna 216. LTE module 202 and WLAN module 210 may be co-located on a common system (e.g., on the same circuit board or on distinct circuit boards within the same system, or may be embedded on the same integrated circuit as in a system on a chip (SoC) implementation). For illustration purposes only, one antenna is shown for each RAT, but wireless communications device 102 may include multiple antennas for each RAT as desired, such as to enable the use of multiple streams. Further, wireless communications device 102 may be configured to share any number of antennas between the RATs using conventional antenna switching techniques.

Wireless communications device 102 may also include host processor (CPU) 218 configured to perform the various computations and operations involved with the functioning of wireless communications device 102. CPU 218 is coupled to LTE module 202 and WLAN module 210 through bus 220, which may be implemented as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent interface. Upper layers of the protocol stacks of the WLAN and LTE systems may be implemented in software as Drivers 222 stored in memory 224 that may be accessed by CPU 218 over bus 220.

As shown, wireless communications device 102 may include coexistence manager 226 implemented as processor-readable instructions stored in memory 224 that may be executed by CPU 218 to coordinate operation of LTE module 202 and WLAN module 210 according to the techniques of this disclosure. According to aspects described below, coexistence manager 226 may be configured to determine characteristics of transmission and reception regarding LTE module 202. In response to these determinations, coexistence manager 226 may adaptively adjust the transmission power of WLAN module 210 to reduce performance degradation experienced during LTE reception.

As discussed above, coexistence manger 226 may predict IMD interference based on operating conditions of LTE module 202 and WLAN module 210. For example, IMD interference may be predicted from the channel currently being employed by WLAN module 210 and an anticipated frequency for an uplink transmission frequency by LTE module 202. From these frequencies, coexistence manager 226 may predict resulting IMD at a frequency corresponding to a downlink reception for LTE module 202. Further, coexistence manager 226 may also determine an anticipated transmit power for LTE module 202. Yet another operating condition determined by coexistence manager 226 may correspond to receive performance at LTE module 202. Receive performance may be determined from a performance indicator, such as the receive signal strength indication (RSSI), the signal to noise ratio (SNR), the receive error vector matrix (EVM), the packet error rate (PER), or any other suitable metric. The performance metric may be reported by WLAN module 210. In one aspect, WLAN transmission power at WLAN module 210 may be reduced when anticipated LTE transmission power at LTE module 202 is above a threshold level, when anticipated LTE transmission frequency at LTE module 202 may be predicted to combine with the WLAN transmission frequency at WLAN module 210 to cause IMD at an LTE downlink frequency, and/or when LTE reception performance is below a threshold level. Further, the amount of reduction in WLAN transmission power may be determined based upon the LTE transmission power, the LTE transmission frequency and/or the quality of the LTE reception.

LTE communications, such as between wireless communications device 102 and base station 104, which may also be known as an evolved Node B (eNB), involve the exchange of packets at frequencies and timings arbitrated by base station 104, and may be based upon information regarding channel conditions as reported by wireless communications device 102. Base station 104 includes a protocol stack including elements corresponding to the LTE protocol stack implemented in wireless communications device 102 through WLAN module 210 and CPU 218. In one aspect, the LTE protocol stack of base station 104 may be configured to distribute network resources among associated clients, including wireless communications device 102, for example.

Network time and frequency resources may expressed in terms of resource blocks (RBs), which may occupy one subframe (1 ms) in the time domain and 12 contiguous orthogonal frequency division multiplex (OFDM) subcarriers for downlink transmissions on the downlink at 15 KHz intervals and 12 contiguous single-carrier, frequency division multiple access (SC-FDMA) signals on the uplink (also at 15 KHz intervals). As a result, each RB spans a 180 KHz bandwidth. FIG. 3 depicts a representation of this basic time-frequency design of LTE. As shown, radio frame 300 may have a duration of 10 milliseconds (ms) and spans a number of RBs 302 in the frequency domain and ten 1 ms subframes in the time domain. The total number of RBs used for any LTE transmission is proportional to the system bandwidth. For example, a 5 MHz system bandwidth requires 25 RBs; while a 10 MHz system bandwidth requires 50 RBs (each transmission bandwidth includes upper and lower guard bands).

The minimum system bandwidth currently specified for LTE Rel-8 is 1.4 MHz (6 RBs) as illustrated in FIG. 3, and the maximum currently specified transmission bandwidth is 20 MHZ (110 RBs). The techniques of this disclosure may be adapted to any changes in these specifications. Each RB 302 may be divided into two slots, such as slot 304 and slot 306, and each slot may span 6 or 7 OFDM symbols on the downlink or SC-FDMA symbols on the uplink (7 shown in FIG. 3). The smallest unit of resource is a resource element (RE) 308, which spans one subcarrier in the frequency domain and one symbol in the time domain. The number of bits per symbol is a function of the modulation scheme and can vary from 2 bits per symbol using quadrature phase shift keying (QPSK) modulation to 6 bits per symbol at 64-state quadrature amplitude modulation (64 QAM). In some transmission modes, resources may be spatially multiplexed in two of more layers as indicated.

Accordingly, during operation of wireless communications device 102, RBs may be allocated by base station 104 for an upcoming uplink transmission from wireless communications device 102. For example, resource allocation for the physical uplink shared channel (PUSCH), also known as uplink scheduling grants, to be used for the upcoming uplink transmission may be controlled by information transmitted using physical downlink control channels (PDCCHs) and may extend over substantially the entire LTE bandwidth. Such allocations may be assigned at least approximately 2 ms before the uplink transmission. In turn, coexistence manager 226 may determine characteristics regarding a scheduled uplink transmission at LTE module 202, including the transmission power and transmission frequency. Coexistence manger 226 may then use one or more of the determined operational characteristics to predict potential IMD and reduce transmit power for WLAN module 210 in response to detection of performance degradation in reception at LTE module 202.

One suitable example of the techniques of this disclosure for dynamically adjusting WLAN transmission power is depicted in reference to the flowchart of FIG. 4. Coexistence manager 226 of wireless communications device 102 may be configured to begin the routine to predict IMD at 400 by receiving an allocation of network resources from base station 104, such as in the form of a RB allocation for an upcoming uplink transmission. Based on the network resource allocation, coexistence manager 226 may determine characteristics of the upcoming uplink transmission in 402. In one aspect, coexistence manager 226 may determine the transmission power of the upcoming uplink transmission. In another aspect, coexistence manager 226 may determine the transmission frequency of the upcoming uplink transmission. Coexistence manager 226 may also assess receive performance at LTE module 202 in 406.

Using these characteristics, coexistence manager 226 may determine whether conditions warrant a reduction in WLAN transmit power as represented by 408. For example, if the determined LTE reception quality is not below a suitable threshold, coexistence manager 226 may determine not to reduce WLAN transmit power and exit as shown in 410. Additionally, coexistence manager may determine that the upcoming uplink transmission is not scheduled to occur at a frequency likely to cause IMD at the LTE downlink frequency or within a desired frequency range and determine not to reduce WLAN transmit power by exiting to 410.

As described above, this may include determining the current channel being used by WLAN module 210. Further, coexistence manager 226 may determine that the upcoming uplink transmission is scheduled to occur at a transmit power not likely to cause sufficient IMD at the LTE downlink frequency, such as by being below a desired threshold, and determine not to reduce WLAN transmit power by exiting to 410. Alternatively, if a desired number of these conditions are met, coexistence manager 226 may be configured to determine an amount by which to reduce transmit power at WLAN module 210 in 412 and then cause settings corresponding to the reduced transmit power to be applied to WLAN module 210 in 414. In one embodiment, coexistence manager 226 may be configured to reduce transmit power for WLAN module 210 when each of the three conditions is met. In other embodiments, coexistence manager 226 may be configured to reduce transmit power for WLAN module 210 when one or two of the conditions are met.

In one aspect, the threshold values used for determining whether the determined LTE transmit power and transmit frequency or LTE reception quality warrant a reduction in WLAN transmit power may be predetermined or dynamically adjusted based on usage conditions or other suitable criteria. For example, values for a range of operating conditions may be determined during a calibration routine and stored in a look up table (LUT) to be retrieved and applied by coexistence manager 226. Similarly, the amount by which WLAN transmit power is reduced may also be predetermined or dynamically adjusted, and appropriate values may be determined by calibration and/or stored in a LUT.

Described herein are presently preferred embodiments. However, one skilled in the art will understand that the principles of this disclosure can be extended easily with appropriate modifications to other applications.

What is claimed is:

1. A wireless communications device, comprising:
a first transceiver configured to operate using a first wireless protocol;
a second transceiver configured to operate using a second wireless protocol; and
a coexistence manager configured to:
receive an allocation of network resources using the first transceiver;
predict intermodulation distortion (IMD) regarding an upcoming transmission using the first transceiver based, at least in part, on at least one characteristic determined from the allocation of network resources; and
selectively reduce transmit power at the second transceiver based, at least in part, on the predicted IMD when reception quality at the first receiver is below a desired threshold.

2. The wireless communications device of claim 1, wherein the at least one characteristic is a transmission frequency for the upcoming transmission;

3. The wireless communications device of claim 2, wherein the coexistence manager is further configured to: determine a current channel on which the second transceiver is operating and predict IMD based, at least in part, on the transmission frequency of the upcoming transmission and the current channel.

4. The wireless communications device of claim 1, wherein the at least one characteristic is a transmission power for the upcoming transmission.

5. The wireless communications device of claim 3, wherein the coexistence manager to predict IMD based, at least in part, on the transmission frequency characteristic and the transmission power characteristic.

6. The wireless communications device of claim 1, wherein the allocation of network resources is a resource block (RB) assignment.

7. The wireless communications device of claim 1, wherein the coexistence manager to determine reception quality at the first receiver based, at least in part, on a performance metric reported by the second transceiver.

8. The wireless communications device of claim 1, wherein the coexistence manager to determine an amount by which to reduce transmission power for the second transceiver based, at least in part, on at least one of the reception quality at the first transceiver and the at least one characteristic determined from the allocation of network resources.

9. The wireless communications device of claim 1, wherein the first wireless protocol is a long term evolution (LTE) protocol and wherein the second wireless protocol is a wireless local area network (WLAN) protocol.

10. A method for providing coexistence between a first wireless protocol and a second wireless protocol, comprising:
receiving an allocation of network resources using the a first transceiver configured to operate using the first wireless protocol;
predicting intermodulation distortion (IMD) regarding an upcoming transmission at the first transceiver based, at least in part, on at least one characteristic determined from the allocation of network resources; and
selectively reducing transmit power at a second transceiver configured to operate using the second wireless protocol based, at least in part, on the predicted IMD when reception quality at the first receiver is below a desired threshold.

11. The method of claim 10, wherein the at least one characteristic is a transmission frequency for the upcoming transmission;

12. The method of claim 11, further comprising determining a current channel on which the second transceiver is operating and predicting IMD based, at least in part, on the transmission frequency of the upcoming transmission and the current channel.

13. The method of claim 10, wherein the at least one characteristic is a transmission power for the upcoming transmission.

14. The method of claim 13, wherein predicting IMD is based, at least in part, on the transmission frequency characteristic and the transmission power characteristic.

15. The method of claim 10, wherein the allocation of network resources is a resource block (RB) assignment.

16. The method of claim 10, wherein determining reception quality at the first receiver is based, at least in part, on a performance metric reported by the second transceiver.

17. The method of claim 10, further comprising determining an amount by which to reduce transmission power for the second transceiver based, at least in part, on at least one of the reception quality at the first transceiver and the at least one characteristic determined from the allocation of network resources.

18. The method of claim 10, wherein the first wireless protocol is a long term evolution (LTE) protocol and wherein the second wireless protocol is a wireless local area network (WLAN) protocol.

19. A non-transitory processor-readable storage medium for providing coexistence between a first wireless protocol and a second wireless protocol in a wireless communications device, the processor-readable storage medium having instructions thereon, when executed by a processor, to cause the wireless communications device to:
receive an allocation of network resources using the a first transceiver configured to operate using the first wireless protocol;
predict intermodulation distortion (IMD) regarding an upcoming transmission at the first transceiver based, at least in part, on at least one characteristic determined from the allocation of network resources; and
selectively reduce transmit power at a second transceiver configured to operate using the second wireless protocol based, at least in part, on the predicted IMD when reception quality at the first receiver is below a desired threshold.

20. The non-transitory processor-readable storage medium of claim 19, wherein the at least one characteristic is a transmission frequency for the upcoming transmission;

21. The non-transitory processor-readable storage medium of claim 20, further comprising instructions to cause the wireless communications device to determine a current channel on which the second transceiver is operating and predicting IMD based, at least in part, on the transmission frequency of the upcoming transmission and the current channel.

22. The non-transitory processor-readable storage medium of claim 19, wherein the at least one characteristic is a transmission power for the upcoming transmission.

23. The non-transitory processor-readable storage medium of claim 22, wherein predicting IMD is based, at least in part, on the transmission frequency characteristic and the transmission power characteristic.

24. The non-transitory processor-readable storage medium of claim 19, wherein the allocation of network resources is a resource block (RB) assignment.

25. The non-transitory processor-readable storage medium of claim 19, wherein determining reception quality at the first receiver is based, at least in part, on a performance metric reported by the second transceiver.

26. The non-transitory processor-readable storage medium of claim 19, further comprising instructions to cause the wireless communications device to determine an amount by which to reduce transmission power for the second transceiver based, at least in part, on at least one of the reception quality at the first transceiver and the at least one characteristic determined from the allocation of network resources.

27. The non-transitory processor-readable storage medium of claim 19, wherein the first wireless protocol is a long term evolution (LTE) protocol and wherein the second wireless protocol is a wireless local area network (WLAN) protocol.
